(19) United States
(12) Patent Application Publication
(10) Pub. No.: US 2021/0107689 A1
(43) Pub. Date: Apr. 15, 2021

(54) METHOD FOR CONTROLLING A MULTI-ENGINE BAY, CONTROL SYSTEM FOR A MULTI-ENGINE BAY AND MULTI-ENGINE BAY

(71) Applicant: ARIANEGROUP SAS, Paris (FR)

(72) Inventors: Serge LE GONIDEC, Vernon (FR); Manuel Sylvain François KLEIN, Vernon (FR)

(73) Assignee: ARIANEGROUP SAS, Paris (FR)

(21) Appl. No.: 16/498,500

(22) PCT Filed: Mar. 27, 2018
(86) PCT No.: PCT/FR2018/050749

§ 371 Date: Sep. 27, 2019

(30) Foreign Application Priority Data
Mar. 28, 2017 (FR) 1752577

(51) Int. Cl. B64G 1/40; F02K 9/80

(52) U.S. Cl. CPC B64G 1/40; F02K 9/80

(57) ABSTRACT

A method of controlling a multi-engine bay in which the following steps are performed: a) controlling the bay so that it delivers desired thrust and each engine is operated in compliance with a set of operating limits for the engine; b) periodically evaluating a level of damage for each of the engines, the level of damage of an engine being information representative of a probability of the engine failing; c) for each engine, periodically evaluating whether its level of damage exceeds a predetermined value; and d) if the level of damage of an engine, referred to as a “damaged” engine, exceeds a predetermined value, modifying at least one operating limit of the damaged engine so that the rate of damage of the damaged engine is less than a predetermined maximum rate of engine damage.

### FIELD OF THE INVENTION

The invention relates to controlling engines in a multi-engine bay, and to monitoring their states. A multi-engine bay is defined herein as being a propulsion assembly comprising a plurality of engines arranged in such a manner as to be capable of generating forces that add together. More particularly, the invention applies to a situation in which the engines are reaction engines, and where the bay is thus constituted by a plurality of rocket engines.

### BACKGROUND OF THE INVENTION

In a multi-engine bay, the state of each of the engines degrades progressively as a function of the length of time the engine has been in use and of the stresses to which it has been subjected in operation. As a result of this degradation, the risk of an engine failing, and consequently of the bay failing, increases progressively during its stages of operation.

A first object of the invention is thus to propose a method of controlling a multi-engine bay that enables the risk of failure of the bay to be contained to a level that is acceptable.

This object is achieved by a method of controlling a multi-engine bay in which the following steps are performed:

a) controlling the bay so that it delivers desired thrust and that each engine is operated in compliance with a set of operating limits for the engine;

b) periodically evaluating a level of damage for each of the engines;

c) for each engine, periodically evaluating whether its level of damage exceeds a predetermined value; and

d) if the level of damage of an engine, referred to as a “damaged” engine, exceeds a predetermined value, modifying at least one operating constraint, also referred to as an “operating limit”, of the damaged engine so that the rate of damage of the damaged engine is less than a predetermined maximum rate of engine damage.

Herein, the level of damage of an engine is information representative of a probability of the engine failing.

Steps a) to d) are normally performed using one or more computers.

If during step c), a plurality of engines are detected as being damaged, then in step d), at least one operating limit is modified for each of them. A limit value from which it is considered that the engine is damaged, or indeed a maximum rate of engine damage, may be defined specifically for each engine instead of using the same value for all of the engines.

An operating constraint or operating limit is an expression defining a subset of the variables space used for controlling the engine, within which the command applied to the engine in question is required to lie. In other words, imposing operating limits for controlling an engine thus constrains it to be controlled in such a manner that the values of the commands that are transmitted thereto (or that are transmitted to its control unit for an engine that possesses its own control unit) remain within the subset as defined in this way.

An operating limit is usually expressed in the form of a relationship or an expression, in particular an inequality, optionally a vector inequality, that defines a subset of the variables space used for controlling the engine. These variables may be state variables of the engine, in particular controlled variables of the engine, e.g. such as actuator positions. An operating limit may optionally be a function of time.

By way of example, these variables that might be involved in the expression for an operating limit may be speeds of rotation of turbopumps, outlet pressures from turbopumps, combustion gas temperatures, or temperatures at the outlet from heat exchangers, etc.

In the above-defined method of the invention, the level of damage of each engine is evaluated periodically. As soon as the level of damage of an engine exceeds a predetermined value, corrective action is triggered to reduce the rate of damage of the engine: one or more operating limits are modified so that the engine is operated in such a manner that its level of damage varies only relatively slowly, i.e. in such a manner that the engine degrades less quickly than it would if the palliative action had not been taken.

Consequently, the method of the invention enables the bay to continue being used without any of the engines degrading quickly; consequently and advantageously, the reliability of the bay diminishes only very slowly, and its loss of reliability is contained as much as possible.

By way of example, modifying the operating limits may include reducing a maximum thrust value for the engine, reducing a maximum mixture ratio that can be accepted by the engine, etc.

Modifying the operating limits in step d) may be performed in any way: adding and/or removing one or more operating limits, and/or modifying one or more operating limits, etc.

The modification to one or more operating limits of the engine, and consequently to the bay, is taken into account in the control that is applied to the engine and consequently to the bay (control step a)).

While performing the method of the invention, the predetermined damaged value from which the set of operating limits of the engine is modified may be determined in particular as a function of the damage curve for the engine as a function of time (or the curve showing the probability of engine failure).

Naturally, the damage to the state of the engine as a function of time may vary in various ways, depending on the stresses to which the engine is subjected. Nevertheless, an engine is often operated with medium or nominal control values; or indeed it may be operated to comply with a predetermined flight plan. Thus, in order to determine the level of damage from which the operating limits of the engine are modified, use is generally made of the curve showing variations in damage as a function of time for the engine operating nominally or for the engine operating in the manner predicted by the flight plan.

The predetermined level of damage from which one or more operating limits of the engine are modified in step d) may then be set to the value at which the rate of damage of the engine exceeds a predetermined threshold, above which the engine degrades quickly. This threshold value is selected on the basis of the curve showing how damage varies as a function of time.

The predetermined value from which the operating limits of the engine are modified may also be determined as a function of the level of damage, e.g. a certain (predetermined) length of time prior to the level of damage being reached.

The modification to one or more operating limits that is then undertaken (step d)) is selected so as to maintain the maximum rate of engine damage below a predetermined value.

Consequently, if the operating limits as modified in step c) are taken into account, the engine is caused subsequently to degrade more slowly than it would have degraded if it were controlled on the basis of the unmodified operating limits that were taken into account before the step d).

As mentioned above, the level of damage of an engine is information representative of a probability of the engine failing.

It is not information relating merely to engine trouble, or even merely to a slight malfunction of the engine (e.g. a drop in power).

It is information (generally continuous and not binary) that provides an estimate of the probability of the engine failing, usually as a function of the operating history of the engine.

The level of damage may be calculated from the levels of damage of the main components of the engine. Thus, by way of example, the level of damage of an engine may be calculated as a function of the maximum of the respective levels of damage of subsystems of the engine. If the engines are all reaction engines, the level of damage may be calculated in particular as a function of the respective levels of damage of the main combustion chamber and of the propellant feed turbopumps of the engine.

By way of example, the level of damage may be determined empirically and/or on the basis of learning causal relationships between one or more measurements and the level of degradation of a subsystem of the engine or of the engine itself. This degradation is cumulative flight after flight; memory concerning preceding flights may be conserved using readings taken during maintenance operations carried out on the engine.

The level of damage of the engine may be determined in particular by integration from the rate of damage of the engine or of its subsystems.

By way of example, for a subsystem of an engine, the rate of damage may be:

1) for a turbomachine, a value that is a function of the vibratory energy of the turbomachine and/or any other appropriate parameter, e.g. accumulated or weighted for various frequency ranges;

2) for an actuator, the value of the electrical power consumed or a function that integrates this value; and/or

3) for a combustion chamber, the “excess” value, i.e. the value exceeding a predetermined upper limit for the mixture ratio of the propellants in the chamber, or indeed a function that integrates this “excess” value.

Furthermore, in a turbomachine, it is well known that the power delivered by the pump of the turbomachine is closely linked with the speed of rotation of the turbomachine. Increasing the power delivered by the pump, or the speed of rotation of the turbomachine, leads to increasing the vibratory energy of the turbomachine, and thus to increasing its rate of damage.

Consequently, in accordance with the invention, reducing the limit speed of rotation of a turbomachine of an engine (when the engine is considered as being damaged) in a multi-engine bay leads to controlling the bay under the constraint of this limit speed for the turbomachine in question; this leads to controlling the bay in a manner that usually requires reducing the power of the pump, and thus its level of vibration, thereby reducing the rate of damage of the engine in question.

In the same manner, with certain valves (e.g. actuators), the holding current needed for holding the valve in position is representative of the hydraulic torque being applied to the valve; the rate of damage of the valve is safely linked to the value of the torque applied to the valve.

Consequently, in accordance with the invention, modifying the operating limits of an engine in a multi-engine bay and having a damaged valve by reducing the maximum value of the position-holding current of the valve leads to controlling the bay in a manner that usually requires the position-holding current of the valve to be reduced, and thus requires the torque that is applied thereto being reduced; this leads to reducing the rate of damage of the engine of which the valve forms a part.

Finally, in a combustion chamber, it is possible to reduce the maximum value of the mixture ratio that is acceptable in the chamber in order to reduce the rate of damage to the chamber, and consequently to the engine of which the chamber forms a part.

In an implementation, for each engine, in step b), the level of damage of the engine is evaluated as a function at least of one level of damage of the engine at an earlier instant. By way of example, the level of damage may be calculated from the level of damage at the instant t−1, plus an estimate of the additional damage suffered between the instant t−1 previously taken into account and the instant t under consideration: the level of damage is calculated by integrating the additional damage that occurs during each time interval. The additional damage values, that represent wear of the engine between instants t−1 and t may be a function of thrust, and/or of vibration, of pressure, of temperature, etc.

A second object of the present invention is to propose a control system for a multi-engine bay serving to control a multi-engine bay while containing the risk of failure of the bay to a level that is acceptable.

This object is likewise achieved by a control system for a multi-engine bay comprising:

a) a control unit suitable for controlling the bay in such a manner that it delivers desired thrust and that each engine is operated in compliance with a set of operating limits for the engine;

b) an engine health evaluation unit configured to evaluate periodically a level of damage for each of the engines; and

c) an operating limit updating unit configured, for each engine, to evaluate periodically whether the level of damage of the engine exceeds a predetermined value, and if the level of damage of an engine, referred to as a “damaged” engine, exceeds a predetermined value, to modify at least one operating level of the damaged engine in such a manner that the rate of damage of the damaged engine is less than a predetermined maximum rate of engine damage.

In an embodiment, the operating limit updating unit is configured to modify said at least one operating limit of the damaged engine by reducing a maximum thrust of the damaged engine.

The system may be embodied in particular in accordance with one or the other of the following two embodiments:

In a first embodiment, referred to as a “bottom-up” embodiment, the control system has an engine computer for each engine, and the operating limit updating unit comprises, in each engine computer, an operating limit updating module configured:
to evaluate periodically whether the level of damage of the engine exceeds a predetermined value;
if the level of damage of the engine exceeds a predetermined value, to modify at least one operating limit of the damaged engine so that the rate of damage of the damaged engine is less than a predetermined maximum rate of engine damage; and
to inform the control unit of the modification applied to said at least one operating limit of the damaged engine; and

the control unit is configured to control the bay while taking account of said modification applied to said at least one operating limit for the damaged engine(s).

In this embodiment, the function of the operating limit updating unit is performed within the engine computers.

In a second embodiment, referred to as a “top-down” embodiment, the control system has a central computer and an engine computer for each engine. Furthermore:

the engine health evaluation unit comprises, in each engine computer, an engine health evaluation module configured to evaluate periodically a level of damage for each of the engines;

the operating limit updating unit comprises, in the central computer, an operating limit updating module configured:
to evaluate for each of the engines whether the level of damage of the engine exceeds a predetermined value, on the basis of the respective levels of damage of the various engines as communicated by their engine health evaluation modules;
for each engine referred to as a “damaged” engine for which the level of damage exceeds a predetermined value, to modify at least one operating limit of the damaged engine in such a manner that the rate of damage of the damaged engine is less than a predetermined maximum rate of engine damage; and
to inform the control unit of the modification applied to said at least one operating limit of the damaged engine(s); and

the control unit is configured to control the bay while taking account of said modification applied to said at least one operating limit for the damaged engine(s).

In this embodiment, and unlike the above embodiment, the function of the operating limit updating unit is performed within the central computer.

The present invention also provides a multi-engine bay including a control system as defined above.

### BRIEF DESCRIPTION OF THE DRAWINGS

The invention can be well understood and its advantages appear better on reading the following detailed description of embodiments shown as nonlimiting examples. The description refers to the accompanying drawings, in which:

FIG. 1 is a diagrammatic side view of a multi-engine bay in a first embodiment of the invention, referred to as a “top-down” embodiment;

FIG. 2 is a diagrammatic side view of a multi-engine bay in a second embodiment of the invention, referred to as a “bottom-up” embodiment;

FIG. 3 is a graph showing, for one engine of the bay shown in FIG. 1, variations in damage to the engine for various values of thrust;

FIG. 4 is a graph showing, for one engine of the bay shown in FIG. 1, variations in the damage and drift in the damage as a function of time for the engine, depending on whether or not the invention is used for controlling the engine; and

FIG. 5 is a flowchart showing the steps of the method of the invention in an implementation.

### DETAILED DESCRIPTION OF THE INVENTION

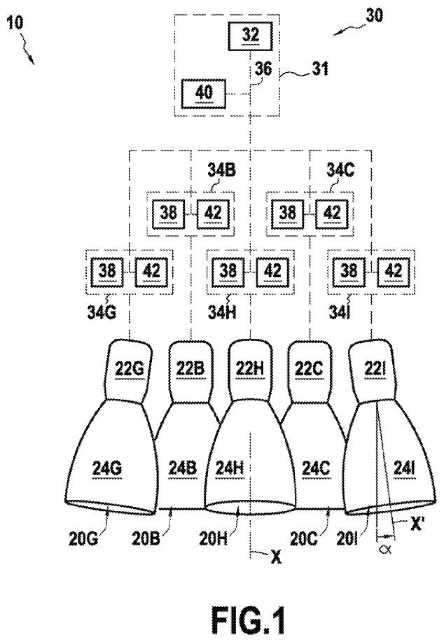

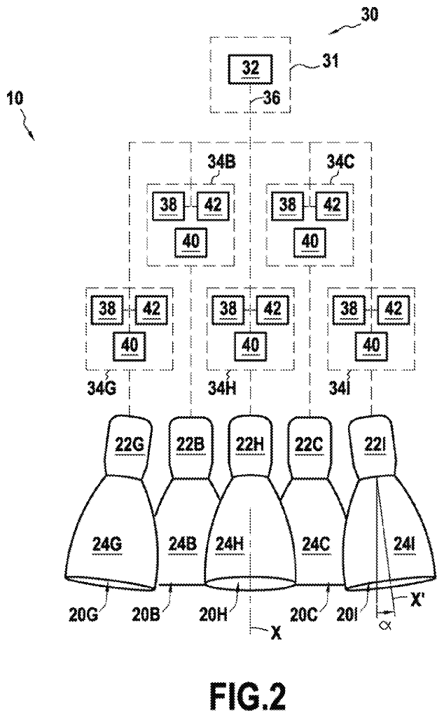

A multi-engine bay 10 is described below in two slightly differing embodiments, with reference respectively to FIG. 1 and to FIG. 2.

In both embodiments, the multi-engine bay 10 comprises 10 engines respectively referenced 20A, 20B, . . . , 20J and referenced collectively as engines 20 (only five engines are shown in FIG. 1).

The bay also has two propellant tanks, circuits for distributing and pressurizing the propellants, and various additional pieces of equipment (not shown).

Each of these engines is a rocket engine comprising a combustion chamber (chambers 22A, 22B, . . . , 22J) each arranged upstream from a nozzle (nozzles 24A, 24B, . . . , 24J). The references 22 and 24 are used respectively to designate collectively the combustion chambers and the nozzles.

The bay 10 is controlled by a control system 30.

The control system 30 comprises a central computer 31 and ten engine computers 34A, 34B, . . . , 34J.

The engine computers 34A, 34B, . . . , 34J and the central computer 31, which exchange information about the operation and the control of the engines, are connected together by a data transmission bus 36.

The control system 30 comprises three functional units: a control unit 32 for overall control of the bay, an engine health evaluation unit 38, and a unit 40 for updating operating limits. It also comprises, for the controlling of the operation of each engine, an engine control unit 42. The control units 32, the engine health evaluation units 38, and the operating limit updating units 40 are functional modules implemented within the control system 30.

The control unit 32 is the unit that calculates commands for transmitting to the various engines 20. By way of example, these commands may be constituted in particular by the value of the thrust that the engines are requested to deliver at a given instant.

In each engine, and on the basis of the command received from the control unit 32, the engine computer 34 calculates the commands to be transmitted to each of the actuators of the engine (commands determining the degree to which adjustable valves are to be opened, etc.), while taking account of the operating limits of the various actuators, and it transmits these commands to the actuators.

All of the calculations performed by the units of the control system 30 are performed in real time in periodic manner so as to ensure continuity of control over the engine.

The control unit 32 calculates the command for the bay in such a manner that the bay delivers the total thrust F desired for the launcher, and that each engine is operated in compliance with a set of operating limits applicable to that engine.

In parallel, while the bay is in operation, the engine health evaluation unit 38 evaluates continuously (i.e. periodically) the state of health, i.e. the state of degradation, of each of the engines, and more broadly of the bay. In particular, the engine health evaluation unit 38 evaluates periodically, at each time step, the damage ENDO of each of the engines; the values of the damage ENDO are transmitted to the operating limit updating unit 40.

The operating limit updating unit 40 (referred to below for simplification purposes as the “unit 40”) is configured to compare the damage of each of the engines with predetermined values for each of the engines.

If, for a given engine, its damage exceeds a predetermined value selected as being the maximum acceptable level of damage, the unit 40 modifies at least one of the operating limits of the engine in such a manner that the rate at which the damaged engine is being damaged is less than a predetermined maximum rate for engine damage dENDO/dt_max.

The modified values of the operating limits are transmitted to the control unit 32, which takes the modified operating limits into account for determining the commands that are to be applied to the engines.

Each of the functional units of the control system 30 performs the calculation steps that are allocated thereto in real time, in cyclical and iterative manner, with a time step size between two calculation cycles that is generally constant.

On each cycle, the control unit 32 calculates the commands (e.g. the thrust setpoints) to be transmitted to the control units 34 of the engines 20; the engine health evaluation unit 38 calculates the respective levels of damage of the various engines 20; the unit 40 compares the damage ENDO of each engine 20 with the maximum acceptable damage value ENDO_S, and when this value is exceeded, modifies one or more of the operating limits of the engine(s) in question.

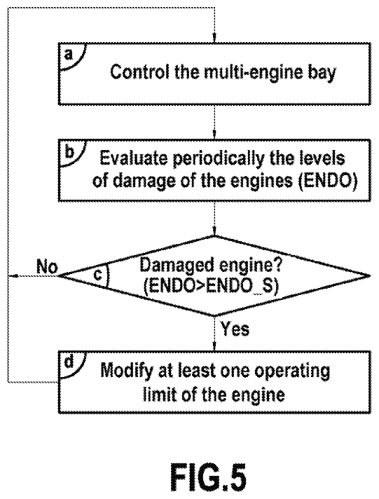

As summarized in FIG. 5, the method being performed thus comprises the following steps:

a) the bay is controlled in such a manner as to deliver the desired thrust, with each engine being operated in compliance with the set of operating limits specified for the engine;

b) the level of damage ENDO of each of the engines is evaluated periodically;

c) for each engine, it is determined periodically whether its level of damage ENDO exceeds a predetermined value ENDO_S; and

d) if the damage of an engine exceeds the predetermined value ENDO_S, the engine is then considered as being damaged; at least one of the operating limits of that damaged engine is then modified so that its rate of damage dENDO/dt is less than a predetermined maximum rate of engine damage dENDO/dt_max.

Each of the steps a), b), c), and d) comprising operations that are performed respectively by the units 32, 38, 40, and 40 (where the unit 40 performs both steps c) and d)) needs to be performed periodically, but these steps may be performed in any order.

There follows a description of the features of two embodiments of the invention, given as examples.

### “Top-Down” Architecture

In the first embodiment (FIG. 1), the electronic control system 30 presents operation that is said to be “top-down” in that in step d) the modifications to the operating limits are performed in centralized manner.

In this embodiment, the engine health evaluation unit 38 is constituted by software modules incorporated within the engine computers 34. While the bay 10 is in operation, for each engine, the engine health evaluation module periodically evaluates the level of damage ENDO of the engine. It then sends a flag to the computer 31 indicating the level of damage.

The operating limit updating unit 40 is constituted mainly by a software module 40 incorporated within the central computer 31.

On the basis of the ENDO flags received from the engine health modules for each engine, the unit 40 periodically evaluates whether the level of damage ENDO of the engine exceeds a predetermined value ENDO_S.

If, on making this comparison, the unit 40 detects that an engine is damaged, it modifies one or more of the operating limits of the engine, in order to guarantee its reliability. In the present example, the unit 40 modifying the operating limits consists in reducing the operating point of the engine, i.e. its maximum nominal thrust. In accordance with the invention, this modification is carried out in such a manner that the rate of damage of the damaged engine is kept below a predetermined maximum rate of engine damage (dENDO/dt_max).

The unit 40 then transmits the maximum nominal thrust values to the control unit 32.

The control unit 32 is constituted mainly by a software module 32 incorporated within the central computer 31. As a function of the modified operating limits received from the operating limit updating unit 40, the control unit 32 calculates the respective thrust values to be delivered by the various engines in order to maintain the overall thrust at the desired value. It sends the respective thrust values as determined in this way to the engine computers 34.

Within the engine computers 34, and as a function of the received trust values, the engine control units 42 act respectively to control the various engines 20.

### “Bottom-Up” Architecture

There follows a description of the architecture of the control system 30 in the second embodiment (FIG. 2). This embodiment is identical to the first embodiment, except for the differences set out below.

In this embodiment, as above, the engine health evaluation unit 38 is constituted by software modules 38 incorporated within the engine computers 34. While the bay 10 is in operation, for each engine, the engine health evaluation module 38 periodically evaluates the level of damage ENDO of the engine.

The operating limit updating unit 40 is constituted mainly by software modules (likewise referenced 40) that are installed within the engine computers 34, in contrast to the above embodiment.

Thus, in this embodiment, in each engine, the damage flag ENDO is sent by the engine health evaluation module 38 to the operating limit updating module 40 within the engine computer 34.

If the damage ENDO of the engine exceeds the predetermined value ENDO_S, the operating limit updating module 40 modifies at least one of the operating limits of the engine so that the rate of damage dENDO/dt of the damaged engine is less than the predetermined maximum rate of engine damage dENDO/dt_max.

The module 40 then transmits the following to the control unit 32:
a first flag “Flag 1” indicating that the maximum thrust value of the engine has been restricted; and
a second flag “Flag 2” indicating the new maximum thrust value of the engine.

Optionally, the second flag may be expressed in the form of a level of efficiency, i.e. the value transmitted by the second flag is merely the ratio between the maximum thrust value to be taken into account, as determined by the module 40, and the initial maximum thrust value defining the nominal maximum thrust of the engine when it is in a perfect state of operation. The level of efficiency thus expresses the ratio between the modified operating limit of the engine (the real maximum thrust of the engine) divided by the nominal (or initial) operating limit of the engine (the nominal maximum thrust of the engine).

As above, the control unit 32 is configured to control the bay while taking account of the modifications made to the operating limits of the various engines.

The operation of the control system 30 can be better understood from a concrete example of an implementation of the method of controlling the bay 10 of the invention.

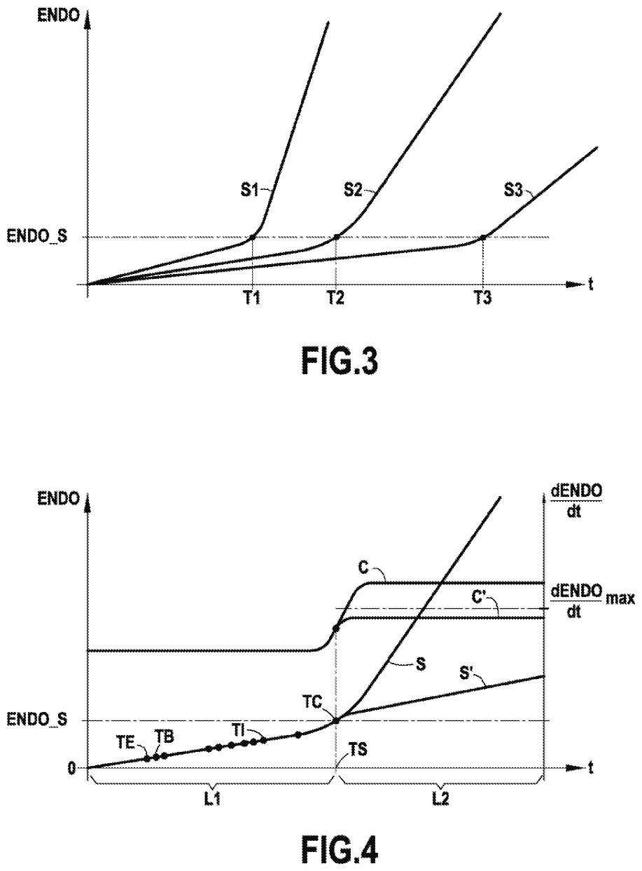

To begin with, there follows a description with reference to FIG. 3 of the process whereby the state of health of the engines 20 becomes degraded.

FIG. 3 is a diagram in the form of curves S (S1, S2, S3) showing how the level of damage ENDO of an engine 20 varies as a function of time. In this diagram, the level of damage ENDO is plotted up the ordinate axis and time is plotted along the abscissa axis. The time derivative level of damage dENDO/dt is referred to as the “rate of damage”.

When a multi-engine bay 10 is used, the level of damage ENDO of each engine increases over time following a curve S.

For each engine 20, the level of damage ENDO increases as a function of the stresses that are applied thereto, i.e. as a function of the thrust that it is called upon to deliver. The rate of damage dENDO/dt of the engines that are the most stressed (i.e. that deliver the greatest thrust) is thus greater than the rate of damage of the engines that are less stressed. The curves S show variations in the level of damage ENDO for different values of thrust demanded of the engine. The curve S1 corresponds to the greatest thrust, and the curve S3 corresponds to the smallest thrust.

Each of these curves presents a first period that continues until the level of damage ENDO reaches a value ENDO_S, and during which the level of damage ENDO increases relatively slowly.

Thus for the engines 20, so long as the level of damage is less than this level of damage ENDO_S, the reliability is excellent and the probability of failure ENDO remains very low.

During this period, the level of damage ENDO increases overall in a manner that is proportional to the duration t for which the engine has been in use, as measured since the most recent maintenance operation on the engine. (Naturally, the level of damage ENDO may be calculated more accurately for an engine by taking more detailed account of the stresses to which it is actually subjected.)

Once the level of damage exceeds the value ENDO_S, and during a second period, the level of damage ENDO starts increasing much more rapidly; as from this level of damage ENDO_S, the engine is considered as being damaged.

The curves S thus serve to distinguish two periods: first periods (ENDO<ENDO_S) during which the probability of failure remains very low, increasing very slowly as a function of time, and second periods (ENDO>ENDO_S) during which the engine degrades much more quickly (a high rate of increase of damage per unit time).

It can be seen that the rate of damage (dENDO/dt) of the engines, during the second period, is correspondingly smaller when the thrust demanded from the engine is low. Thus, during the second period, the slope of the curve S3 is smaller than the slope of the curve S2 and much smaller than the slope of the curve S1.

In this example, it is considered that the rate of damage of the engine for thrust corresponding to the curve S3 and as occurring in the second portion of the curve S3 (t>T3), is a rate of damage that is acceptable, given the mission to be performed by the rocket.

Consequently, by constraining the engine so that its thrust is no greater than the thrust corresponding to the curve S3 thus serves to ensure that the rate of damage of the engine is less than (or at worst equal to) a predetermined value dENDO/dt_max that is considered as being acceptable (this is the rate of damage of the engine during the second period with the curve S3).

The invention makes use of this property as follows: as soon as it is observed that an engine is damaged, with the level of damage of the engine exceeding the predetermined value ENDO_S (i.e. as soon as the engine starts operating in the second period), one or more of its operating limits are modified (in the present example: the maximum thrust that might be demanded of the engine is reduced), so that the engine is operated at an operating point (for thrust demand) at which its rate of damage is less than a rate of damage that is considered as being the maximum acceptable rate of damage dENDO/dt_max.

Thus, in the example in question, as soon as it is observed that the level of damage to the engine reaches the value ENDO_S, the maximum thrust that can be demanded of it is reduced by setting the maximum thrust of the engine to the thrust corresponding to the curve S3. From that moment, the thrust that is calculated for the engine is necessarily less than that maximum thrust: consequently, as from this instant, the thrust demanded from the engine is less than the thrust corresponding to the curve S3 and presenting a rate of damage that is relatively low. Consequently, as from this instant, the rate of damage of the engine remains less than dENDO/dt_max.

This action is not undertaken by directly reducing the thrust demanded of the engine, but by imposing a change to an operating limit of the engine (namely the limit value for the maximum thrust of the engine. Naturally, any other operating limit could be selected, e.g. such as the maximum speed of rotation of a pump, etc., . . . ).

The modification to an operating limit or to an operating constraint is determined by the module 40 and is subsequently taken into account by the bay control unit (module 32), thereby leading, usually, to a reduction in the thrust from the engine.

The operation obtained from the bay is shown in FIG. 4.

The presently-envisaged scenario is that of a reusable launcher in which the multi-engine bay 10 has engines 20 for which maintenance has been performed more or less recently depending on the engine in question. Thus, at a particular instant of flight, the engines present respective failure probabilities TA, TB, . . . , TJ.

The object is to keep the level of damage (the probability of failure) of each of the engines as at low a level as possible throughout the duration of the mission. The failure probabilities of the various engines are marked in FIG. 4 in the form of points on the curve S.

FIG. 4 is in the form of curves S, S′ and C, C′ showing variations respectively in the level of damage ENDO and in the time derivative of the level of damage dENDO/dt for a given engine 20 and for two different scenarios.

In both scenarios, the level of damage ENDO of the engine 20 under consideration reaches the value ENDO_S at an instant TS at the end of a first period L1.

In the first scenario (curves S and C), the invention is not performed, whereas in the second scenario (curves S′ and C′), the invention is performed by modifying at least one of the operating limits of the engine 20 in question, namely by reducing the maximum thrust that can be demanded of the engine.

In the first scenario, since no action is triggered at the instant TS, the engine passes into a second operating period L2.

During this second operating period L2 (t>TS), in the first envisaged scenario the engine 20 under consideration is used at its maximum thrust; its level of damage increases quickly and its rate of damage is greater than dENDO/dt_max (curve C).

Conversely, in the second scenario, as soon as it is detected that the level of damage of the engine 20 under consideration has reached the value ENDO_S, the operating limits are modified by reducing the maximum thrust value that can be demanded of this engine.

This modification leads to a reduction in its rate of damage, which is represented by the fact that the curve C′ lies under the chain-dotted line in FIG. 4 corresponding to the value dENDO/dt_max. Consequently, this enables the mission to be continued in such a manner that the level of damage at the end of the mission is less than it would have been if the operating limits had not been modified.

The modification to the operating limits of the engine 20 that was detected as being damaged at instant TS, i.e. reducing the maximum thrust of the engine 20, constrains the control unit 32 of the bay to recalculate commands for this engine. These commands are recalculated while taking account of the modified value for the maximum thrust for this engine. The commands as recalculated in this way for the engine 20 may be modified or not modified by the changes to the operating limits of this engine.

As a result of modifying the operating limits for the engine 20, the rate of damage dENDO/dt of the engine after the instant TS is necessarily lower than it would have been if the operating limits (specifically the maximum thrust of the engine) were not modified.

Consequently, modifying the operating limits of the engine 20 in step c) leads to a reduction in the rate of degradation of the engine under consideration and can thus contribute to increasing the rate of degradation of the other engines in the bay. Nevertheless, since the other engines have lower levels of damage, their rates of degradation are advantageously lower and consequently the strategy being adopted serves to reduce the increase in the overall damage of the bay, i.e. the risk of losing an engine, which is increasing as a function of time.

In order to modify one or more operating limits of an engine so that its rate of damage is decreased, various strategies may be adopted (i.e. various modifications may be made to operating limits). Given the number of operating limits of a reaction engine, it is not possible to list them all herein.

A main strategy for reducing the rate of damage of the engine is merely to reduce the maximum thrust that may be delivered by the engine. Under such circumstances, all of the operating limits of the engine are modified by reducing the maximum thrust value taken into account for controlling the engine.

Another strategy may consist in reducing the maximum mixture ratio for the engine. The value of the mixture ratio determines in particular the temperature reached by the combustion gas within the chamber; the higher this temperature, the faster the degradation of the chamber, i.e. the greater the rate of damage to the engine.

Another strategy may consist in reducing the maximum rates at which one and/or the other of the propellants is/are fed to the engine. Reducing these rates serves to reduce the maximum speed of rotation of the propellant feed turbopump(s), and thus to reduce their rate of damage, and consequently the rate of damage of the engine.

1. A method of controlling a multi-engine bay in which the following steps are performed:
a) controlling the bay so that it delivers desired thrust and that each engine is operated in compliance with a set of operating limits for the engine;
b) periodically evaluating a level of damage for each of the engines, the level of damage of an engine being information representative of a probability of the engine failing;
c) for each engine, periodically evaluating whether its level of damage exceeds a predetermined value; and
d) if the level of damage of an engine, referred to as a “damaged” engine, exceeds a predetermined value, modifying at least one operating limit of the damaged engine so that the rate of damage of the damaged engine is less than a predetermined maximum rate of engine damage.

2. A control method according to claim 1, wherein the modification to the operating limit(s) of the engine includes reducing a maximum thrust value of the engine.

3. A control method according to claim 1, wherein the level of damage of an engine is calculated as a function of a maximum of respective levels of damage of subsystems of the engine.

4. A control method according to claim 1, wherein, for each engine, in step b), the level of damage of the engine is evaluated as a function at least of a level of damage of the engine at an earlier instant.

5. A control system for a multi-engine bay, the control system comprising:
a) a control unit suitable for controlling the bay in such a manner that it delivers desired thrust and that each engine is operated in compliance with a set of operating limits for the engine;
b) an engine health evaluation unit configured to evaluate periodically a level of damage for each of the engines, the level of damage of an engine being information representative of a probability of the engine failing; and
c) an operating limit updating unit configured, for each engine, to evaluate periodically whether the level of damage of the engine exceeds a predetermined value, and if the level of damage of an engine, referred to as a “damaged” engine, exceeds a predetermined value, to modify at least one operating level of the damaged engine in such a manner that the rate of damage of the damaged engine is less than a predetermined maximum rate of engine damage.

6. A control system for a multi-engine bay according to claim 5, wherein the operating limit updating unit is configured to modify said at least one operating limit of the damaged engine by reducing a maximum thrust of the damaged engine.

7. A control system for a multi-engine bay according to claim 5, comprising an engine computer for each engine, and wherein:
the operating limit updating unit comprises, in each engine computer, an operating limit updating module configured:
to evaluate periodically whether the level of damage of the engine exceeds a predetermined value;
if the level of damage of the engine exceeds a predetermined value, to modify at least one operating limit of the damaged engine so that the rate of damage of the damaged engine is less than a predetermined maximum rate of engine damage; and
to inform the control unit of the modification applied to said at least one operating limit of the damaged engine; and
the control unit is configured to control the bay while taking account of said modification applied to said at least one operating limit for the damaged engine(s).

8. A control system for a multi-engine bay according to claim 5, having a central computer and, for each engine, an engine computer, and wherein:
the engine health evaluation unit comprises, in each engine computer, an engine health evaluation module configured to evaluate periodically a level of damage for each of the engines;
the operating limit updating unit comprises, in the central computer, an operating limit updating module configured:
to evaluate for each of the engines whether the level of damage of the engine exceeds a predetermined value, on the basis of the respective levels of damage of the various engines as communicated by the engine health evaluation modules thereof;
for each engine referred to as a “damaged” engine for which the level of damage exceeds a predetermined value, to modify at least one operating limit of the damaged engine in such a manner that the rate of damage of the damaged engine is less than a predetermined maximum rate of engine damage; and
to inform the control unit of the modification applied to said at least one operating limit of the damaged engine(s); and
the control unit is configured to control the bay while taking account of said modification applied to said at least one operating limit for the damaged engine(s).

9. A multi-engine bay including a control system according to claim 5.
